(19) United States
(12) Patent Application Publication
(10) Pub. No.: US 2014/0214768 A1
(43) Pub. Date: Jul. 31, 2014

(54) REDUCING BACKUP BANDWIDTH BY REMEMBERING DOWNLOADS

(71) Applicant: HEWLETT-PACKARD DEVELOPMENT COMPANY, L.P., Fort Collins, CO (US)

(72) Inventors: Mark David Lillibridge, Mountain View, CA (US); Joseph A. Tucek, Palo Alto, CA (US)

(73) Assignee: Hewlett-Packard Development Company, L.P., Fort Collins, CO (US)

(21) Appl. No.: 13/755,311

(22) Filed: Jan. 31, 2013

(51) Int. Cl. G06F 17/30

(52) U.S. Cl. CPC G06F 17/30289
USPC 707/645

(57) ABSTRACT

Systems and methods of reducing backup bandwidth by remembering downloads to a computing device. An example method may include remembering information for a download to a computing device. The method may also include backing up the computing device to a different system. The information remembered for the download is used to provide a backup of the computing device without copying some of the downloaded data present on the computing device from the computing device.

### BACKGROUND

Consider a mobile or personal computing device to be backed up using an online or “cloud” service provider. All new and changed data on the device has to be uploaded to the service providers storage for every backup. Routine backups may occur weekly, daily, or even more frequently. Uploading the data to be backed up consumes expensive and sometimes slow bandwidth. Reducing bandwidth consumption can add value for consumers and enterprises, especially those using an asymmetrical link such as a cable modem or digital subscriber line (DSL).

A number of techniques are directed at improving backup operations. These include, for example, compression algorithms and deduplication. While compression algorithms may reduce the amount of data that has to be transferred for backup, compression/decompression may increase the time it takes to complete a backup operation. Deduplication also reduces the amount of data that has to be transferred for backup, but uses extensive indexing which can also increase the time it takes to complete a backup operation.

### BRIEF DESCRIPTION OF THE DRAWINGS

FIG. 1 is a high-level illustration of an example system that may be implemented for reducing backup bandwidth by remembering downloads to a computing device.

FIGS. 2a-b show example architectures for reducing backup bandwidth by remembering downloads to a computing device, including executable machine readable instructions.

FIG. 3 is a high-level illustration of reducing backup bandwidth by remembering a source of downloads to a computing device.

FIG. 4 is another high-level illustration of reducing backup bandwidth by remembering downloads to a computing device via a proxy.

FIGS. 5 and 5a-c are flowcharts illustrating example operations that may be implemented to reduce backup bandwidth by remembering downloads to a computing device.

### DETAILED DESCRIPTION

In an era of electronic data, backups are routine for enterprises and even individuals who desire to backup their personal computers, laptops, tablets, and mobile devices. In an effort to provide backup service regardless of a user's location, and to make the backup process as seamless and effortless as possible, online or cloud backup services have become commonplace. As noted above, however, uploading the data to be backed up can be slow and/or expensive, especially over asymmetrical network connections (e.g., upload speeds are sometimes only one-tenth of download speeds).

Much of the data found on computing devices is retrieved from online or network locations (e.g., the Internet and/or enterprise networks). The systems and methods disclosed herein track data on devices that has been downloaded from a network. Example data that is available from these networks may include, but is not limited to email, application software and “mobile apps,” and PDF documents. In an example, the systems and methods remember the new downloaded data off of the computing device, and/or remember a source of where the new downloaded data came from. As such, the backup provider is able to retrieve the data without having to upload that data from the device.

An example system may include program code stored on one or more non-transient computer-readable storage mediums. The program code is executable by one or more processors to remember information for a download to a computing device, and backup the computing device to a different system. The information remembered for the download is used to provide a backup of the computing device without copying some of the downloaded data present on the computing device from the computing device.

In an example, the program code is further executable by the one or more processors to determine which pieces of data on the computing device are available from a source of the downloaded data, and retrieve those pieces of the data from the source of the downloaded data instead of from the computing device. In another example, the program code is further executable by the one or more processors to route the download for the computing device through at least one proxy node, store a copy of the downloaded data at the at least one proxy node, and remember that the downloaded data is stored at the at least one proxy node (e.g., for restore operations). It is noted that modern mobile device browsers are already often having their requests routed through online proxies, which may be modified as described herein so as not to add latency.

It is noted that the systems and methods described herein may be implemented orthogonal to existing backup techniques, and indeed may even be practiced in combination with those techniques. For example, the techniques disclosed herein may be integrated with deduplication, where for example, deduplication is used to transfer a modified version of downloaded data present on the computing device by deduplicating it against the originally downloaded data, which can be retrieved from other than the computing device using the systems and methods described herein and the remembered information.

Other backup techniques now known or later developed, may also be used to backup data on the computing device that has not been downloaded (e.g., created on the computing device by taking a picture) or that is downloaded data but had no information remembered about it for whatever reason.

The specific bandwidth savings realized by using the techniques described herein depend at least to some extent on empirical factors that can be determined on a case-by-case basis. An example factor includes how much new or “unique” data is downloaded to a device between backup operations. It is noted that the term “unique” is used herein to mean either “actually unique” or sufficiently far down a long tail that it is not cost effective to deduplicate against that data.

It is noted that in an example, the systems and methods described herein are directed generally to backing up the computing device, not the downloaded data. By the time the backup occurs, some of the downloaded data may no longer be present on the computing device. The systems and methods described herein allow for cases where the user modified the downloaded data and/or the download source has been updated since the last backup.

Before continuing, it is noted that as used herein, the terms “includes” and “including” mean, but is not limited to, “includes” or “including” and “includes at least” or “including at least.” The term “based on” means “based on” and “based at least in part on.”

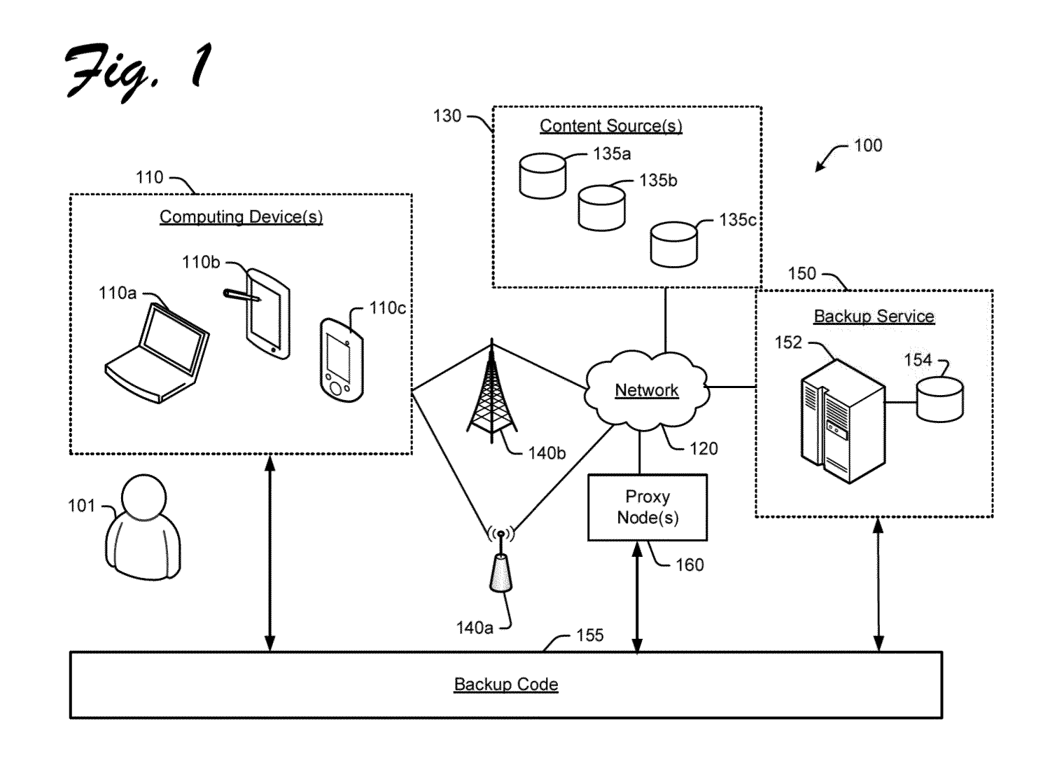

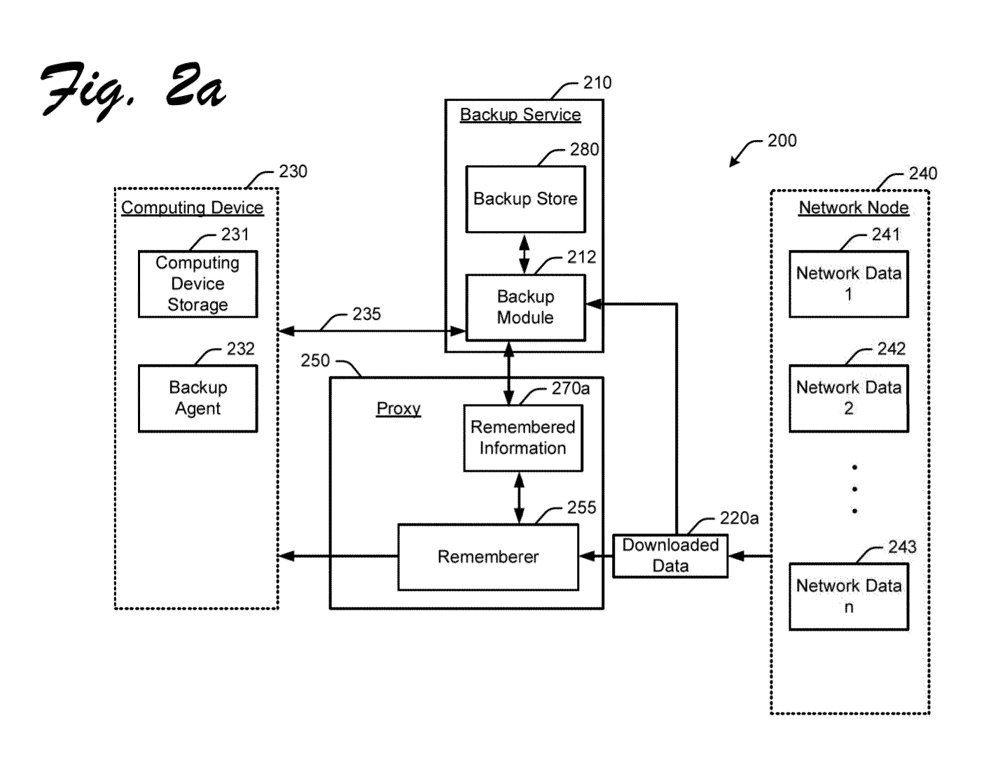

FIG. 1 is a high-level block diagram of an example system 100 that may be implemented for reducing backup bandwidth by remembering downloads to a computing device. System 100 may be implemented with any of a wide variety of computing devices 110, such as, but not limited to, personal computers and laptops 110a, and mobile devices (e.g., tablet devices 110b and smart phones 110c), to name only a few examples. Each of the computing devices may include memory, storage, and a degree of data processing capability at least sufficient to manage a communications connection via a communication network 120, such as the Internet.

The communication network 120 may provide a user 101 with access to network sites 130 (e.g., a website), including one or more content sources 135a-c. The content source 135a-c may be a remote source of content (e.g., provided on a wide area network or WAN such as the Internet or an enterprise network), and/or a distributed source of content.

The content source 135a-c may include any type of content. For example, the content source 135a-c may include email services, applications, databases and other storage resources for providing documents, videos, audio, and other data files. There is no limit to the type or amount of content that may be provided by a source. In addition, the content may include unprocessed or “raw” data, or the content may undergo at least some level of processing.

The computing devices 110 may access the network sites 130 via communications network 120. The communications network 120 may be accessed through any suitable connection, such as a carrier network 140a (e.g., a 3G or 4G network) and/or wired or wireless access point or WAP 140b (e.g., WiFi).

Typically in consumer systems, download speeds are much faster than upload speeds. Thus, users may experience fast downloads, but, online backup services may prove slow when uploading data from the computing devices 110 using an online or cloud backup service. Also, the user may be subject to bandwidth caps (e.g., a limit to how much bandwidth he may consume per month) and may wish to spend the limited bandwidth available watching movies, for example, rather than running backups. Therefore, the system 100 may include a backup service 150 to reduce backup bandwidth by remembering downloads to the computing devices 110.

The backup service 150 may be configured as server computer(s) 152 with computer-readable storage(s) 154. For purposes of illustration, the backup service 150 may be an online service executing program code or backup code 155. The backup code 155 may be executable by one or more processors (e.g., by server computer(s) 152) to backup the computing devices 110 to a different system from computing devices 110 (e.g., storage 154 or other storage system). The backup service 150 may arrange for information to be remembered for a download. For example, instructions for using the service may instruct the user to set his or her browser to use a proxy on the mobile device, or the user may download an “app” including some or all of backup code 155 to the mobile device to setup and/or perform backup. Other examples are also contemplated. The remembered information enables providing backup of the computing device 110 without having to upload at least some of the downloaded data present on the computing device 110 from the computing device 110.

In an example, the backup code 155 may determine which pieces of data on the computing device(s) 110 are available from an online source that provided the downloaded data. As such the backup service 150 can retrieve those pieces of the data directly from the online source of the downloaded data without having to upload those pieces of data from the computing devices 110. In another example, the backup service 150 may arrange for downloads for the computing device(s) 110 to be routed through proxy node(s) 160. A copy of the downloaded data is stored at the proxy node(s) 160. Accordingly, the backup service 150 only has to remember that a copy of the downloaded data is stored at the proxy node and use that copy, instead of having to upload the downloaded data from the computing device(s) 110. Accordingly, the backup service reduces the amount of data that needs to be uploaded during a backup operation, while still having the data available for restore operations.

The program code (e.g., backup code 155) may be implemented using application programming interfaces (APIs) and related support infrastructure. In an example, the operations described herein may be executed by program code residing on the computing device(s) 110 (e.g., as an “app” on a mobile device), at the backup service 150 (e.g., a separate computer system having more processing capability, such as a server computer 152 or plurality of server computers 152), and/or at the proxy node(s) 160.

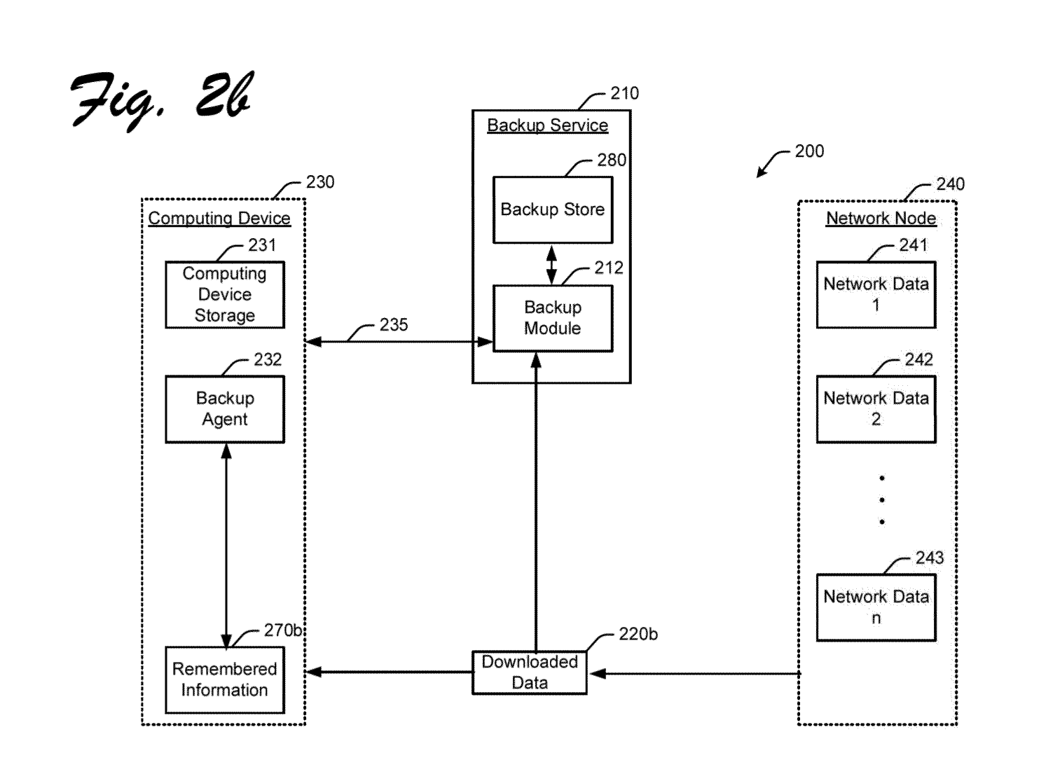

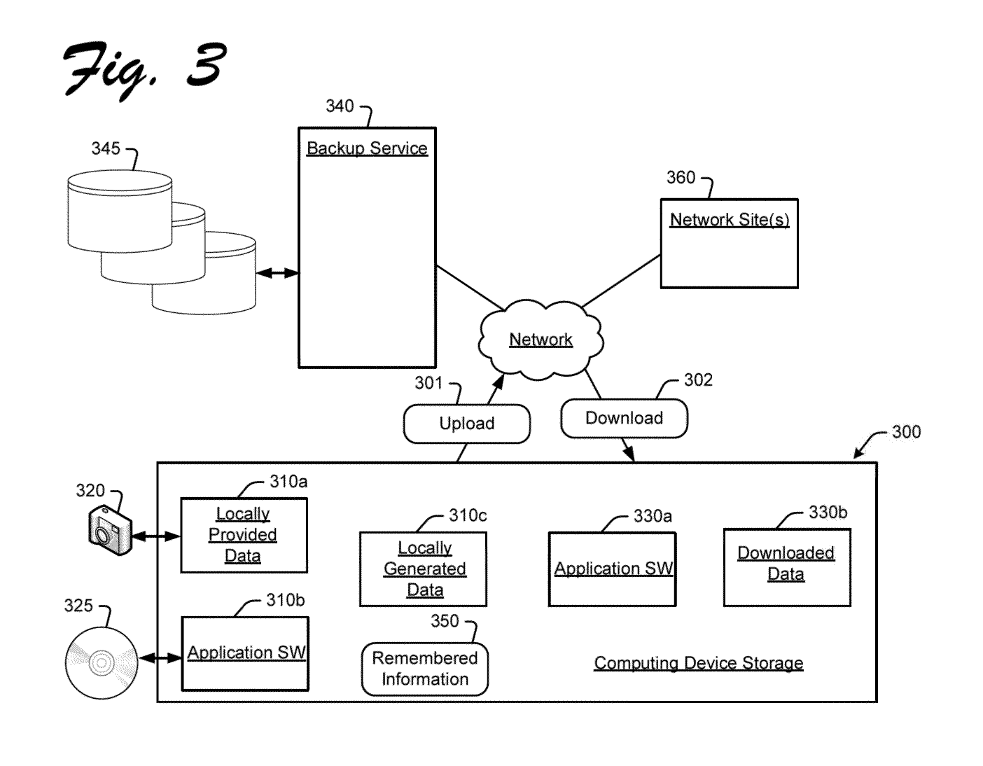

Program code used to implement features of the system can be better understood with reference to FIGS. 2a-b and the following discussion of various example functions. However, the operations described herein are not limited to any specific implementation with any particular type of program code.

FIGS. 2a-b show example architectures for reducing backup bandwidth by remembering downloads to a computing device, including executable machine readable instructions. The program code discussed above with reference to FIG. 1 may be implemented via machine-readable instructions (which may be provided as but not limited to, software or firmware). The machine-readable instructions may be stored on one or more non-transient computer readable mediums and are executable by one or more processors to perform the operations described herein. It is noted, however, that the components shown in FIGS. 2a-b are provided only for purposes of illustration of an example operating environment, and are not intended to limit implementation to any particular system.

The program code may include the machine readable instructions, and may be structured as self-contained modules. These modules can be integrated within a self-standing tool, or may be implemented as agents that run on top of an existing program code.

In the example shown in FIG. 2a, the architecture of program code (e.g., program code 155 shown in FIG. 1) may include a backup module 212 that runs at a backup service 210, a backup agent 232 on the computing device 230 (e.g., device 110 in FIG. 1) and/or a rememberer agent 255 on a proxy 250. It is noted that although only one proxy 250 is shown in FIG. 2a to simplify the illustration, multiple proxy nodes may be utilized. It is also noted that the proxy 250 is shown separate from the backup service 210, but may also be implemented as part of the backup service 210 for multiple backup services, not shown).

In a first illustration, all downloads are routed through a proxy 250. Rememberer 255 in proxy 250 may remember downloads by computing device(s) 230 for a given time, such as all downloads since the last backup or all downloads during the last 24 hours. Different computing devices 230 may each be assigned to different proxy nodes. Or the same proxy 250 may be used for multiple computing devices 230, with an individual proxy 250 remembering which device downloaded the corresponding data 220a.

The proxy 250 may be provided by an Internet service provider (ISP) for the computing device 230, or as a separate backup provider node. In the case of an ISP, the ISP itself may be providing the backup service 210, or the ISP may be a “middleman” that remembers data for a separate backup service 210. In the case of a non-ISP proxy, the computing device software may fetch information through the proxy.

In the example shown in FIG. 2b, the architecture of program code (e.g., program code 155 in FIG. 1) may include a backup module 212 that runs at a backup service 210, and a backup agent 232 on the computing device 230 (e.g., device 110 in FIG. 1).

In the example shown in FIG. 2a, the rememberer agent 255 remembers information 270a about data 220a that the computing device(s) 230 downloaded from network node(s) 240. In the example shown in FIG. 2b, the backup agent 232 on the computing device 230 remembers information 270b about data 220b that the computing device(s) 230 downloaded from network node(s) 240.

In both of the examples shown in FIGS. 2a-b, the backup service 210 attempts during a backup operation to upload only data from computing device storage 231 that was not downloaded. Data 220b that was downloaded from the network is attempted to be retrieved from the network node 240 (e.g., network data 241-243) while data 220a is attempted to be retrieved from proxy 250, where a copy of it may have been stored as part of remembered information 270a.

In both of these examples, the backup service 210 uses the remembered information 270a-b to reduce backup bandwidth. To do this, the backup service 210 associates pieces of the data found in the computing device storage 231 with previously made downloads. There are many ways that this can be implemented. An example is to remember which file name each download is (initially) saved to. At backup time, if a given file has to be backed up because the file has changed since the last backup (e.g., newer modified time), the file name can be compared against the remembered information to see if the file originally resulted from a download, and if so which download.

Another example implementation is to remember a hash of each entire downloads data as part of the remembered information about that download. At backup time, the backup agent 232 can hash each entire changed or new file and check to see if any downloads hash matches that hash. If so, that file includes the downloaded data from that download. A similarity signature may be substituted for the hash here, wherein mostly similar or identical files are likely to have identical similarity signatures, while other files have different similarity signatures. This allows a file to continue to be associated with a download even if it is modified somewhat.

Similarity signatures have been used in other applications. However, similarity signatures have not been used as described herein.

Yet another example implementation involves keeping track at the chunk level, rather than the file level. Here, each file (stored or downloaded) is divided into chunks and information about each chunk (including its hash) is remembered. It is noted that a chunk is a small (e.g., 4-8 KS average size) piece of data. Data may be divided into chunks using landmarks so that local changes tend to change only a few chunks.

When data is downloaded by computing device 230, the data may be chunked and the hashes of the chunks remembered as part of the remembered information about that download. The information about each chunk may include its length and offset in the downloaded data. This allows retrieving the chunk's data from a copy of the downloaded data. At backup time, modified files may be chunked and each of their hashes looked up to see if they are part of any download. Even if a file that was originally downloaded has been modified, many of its chunks may not have been modified. Similarity signatures can be substituted for hashes here as well.

With these methods, pieces of data are found on computing device storage 231 that are associated with recent downloads. In some cases, a data piece is known to be the same as originally downloaded (e.g., hashes match). In those cases, the backup service 210 attempts to retrieve the piece of data without having to upload it from computing device 230. The backup service 210 may do this by attempting to fetch the data from the copy made at proxy 250 when the download occurred (FIG. 2a) or from the source it was downloaded from (FIG. 2b). Note in the latter case that the backup service 210 retrieves the downloaded data 220b directly, without the data passing through computing device 230 or consuming the bandwidth of computing device 230. If the retrieved data from the original source has changed too much (e.g. a hash is different from the remembered hash at the file level or the relevant bytes have a different hash at the chunk level), then either the given piece of data can be uploaded from the computing device 230 or processing may proceed as in the next case.

In some cases, a data piece may not be known to be the same as the originally downloaded data piece (e.g., similarity signatures were used or the file the download was made to is known to have changed due to its modification time). Here, the piece of data resides on computing device 230 and the associated piece of originally downloaded data can usually be retrieved by the backup service 210. While these may be different, the data may not be that different, having only small local changes. To efficiently transfer the piece of data on computing device 232 to backup store 280, the backup service 210 may do a low bandwidth mode deduplication against the piece of data that the backup service is able to retrieve.

Here, both pieces of data are broken up into sub-pieces of data (e.g., a file may be broken up into chunks or large sized chunks broken up into smaller chunks). A hash is computed for each sub-piece of data, and the resulting lists of hashes are compared. Sub-pieces of data on computing device storage 231 that share their hash with a sub-piece of data that is retrievable by backup service 210 need not be uploaded to backup service 210. Instead, these sub-pieces of data can be directly retrieved by backup service 210. The other sub pieces of data on computing device storage 231 can be uploaded from computing device 230. They include data that is not part of the original download. Backup service 210 can then combine all the sub pieces of data that have been acquired to re-create the piece present on computing device storage 231.

To reduce the amount of storage needed, some optimizations may be implemented. For example, when the computing device 230 knows that the data it has downloaded is not being saved, the information remembered about that download may be discarded. This may involve the computing device 230 signaling the backup service 210 or proxy 250 to discard that information, including the copy of the downloaded data, immediately.

In another example, recently downloaded data not seen during the next backup was not saved by the computing device 230, and can have its associated remembered information (including the copy of the downloaded data at a proxy 250, if any) be deleted. It is noted that in the case of multiple devices downloading the same data, any copy of the downloaded data at proxy 250 may be discarded only after it is known that no other computing device 230 using the proxy 250 saved it but has not yet been backed up. Potentially, downloads whose data is known not to be saved by any of the computing devices 230 (except possibly computing devices 230 that have missed the last couple of backups) may have their associated remembered information be discarded as well.

Remembered copies of the downloaded data's chunks (e.g., at proxy 250) not incorporated into a backup (e.g., in backup store 280) may be discarded after every device that downloaded the downloaded data has completed a backup. These chunks were downloaded, but not kept by the computing device 230 or were modified to produce new chunks.

In another example, heuristics may be deployed to discard first remembered information about data thought least likely to be saved. For example, MP3s and PDFs are more likely to be saved than HTML pages, and thus information about downloads of HTML pages may be discarded before information about downloads of MP3 and PDF files.

In a second illustration, the computing device 230 (or the ISP or proxy 250) remembers where data was downloaded from (e.g., URL, any cookies used, etc.) and the hashes, links, and offsets of the chunks that make up the downloaded data. Hashing can be done either on the computing device 230 or a node that the data passes through during a download (e.g., proxy 250). During a backup operation, deduplication is done as usual except that the remembered hash lists are also consulted. If a chunk has a match with a remembered hash only then the backup service 210 uses this information and is given/has the associated information to either try and directly retrieve the download data from the network node 240 and extract the corresponding chunk(s), or extract the chunk(s) directly from the copy made at proxy 250.

It is possible that the retrieval from the network node 240 fails (e.g., non-cookie form of password protection; cookie has expired; SSL being used). It is also possible that the retrieval appears to work, but the returned data at the location of the desired chunk has a different hash because the underlying data at the network node 240 has changed. In either case, the chunk may be uploaded from the computing device(s) 230.

In cases where data requires a current SSL connection for retrieval, the computing device 230 may assist the backup service 210 by opening a new SSL connection through the backup service 210, which the backup service 210 then uses to retrieve the downloaded data. In another example, computing device 230 may be configured to trust not only SSL certificates signed via one of the usual roots of trust (e.g., VERISIGN or DIGICERT), but to also trust certificates issued by the internet service provider (ISP) or the backup provider, such that backup service 210 or proxy 250 may perform a “man-in-the-middle” (MITM) “attack” against computing device 230 and hence access the data (or the identifier for the data and associated authentication information such as cookies) by bypassing the SSL encryption. Although bypassing SSL via a MITM attack may be controversial, and raises some reputational risk for the provider of the backup service, for mobile devices which use exceptionally expensive bandwidth, performing a MITM against SSL may be implemented.

White some data may no longer be retrievable (and hence needs to be uploaded), this illustration (FIG. 2b) uses less or even no storage separate from the computing device 230 for remembering information.

The illustrations described above may also be combined. For example, data that is hard to retrieve (e.g. SSL, certain dynamically changing websites) may be directly remembered, and data that is easy to retrieve may only be remembered by location and hash(es). Likewise, some files may be remembered at the whole file level, and other files may be remembered at the chunk level. The more likely a file seems to be only partially saved (e.g., saved then partially overwritten or changed), the more that may be remembered at the chunk level.

It is noted that local deduplication may also be implemented, at least at the file level in order to conserve space, and store only a single copy of data at proxy 250 and/or at backup store 280.

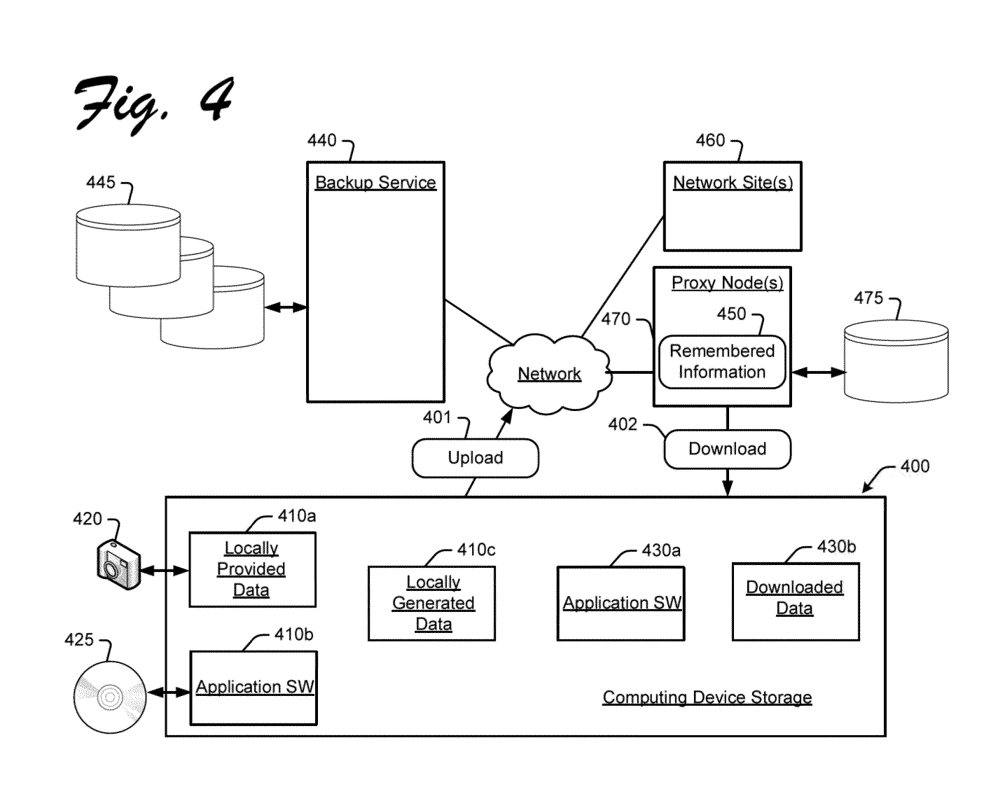

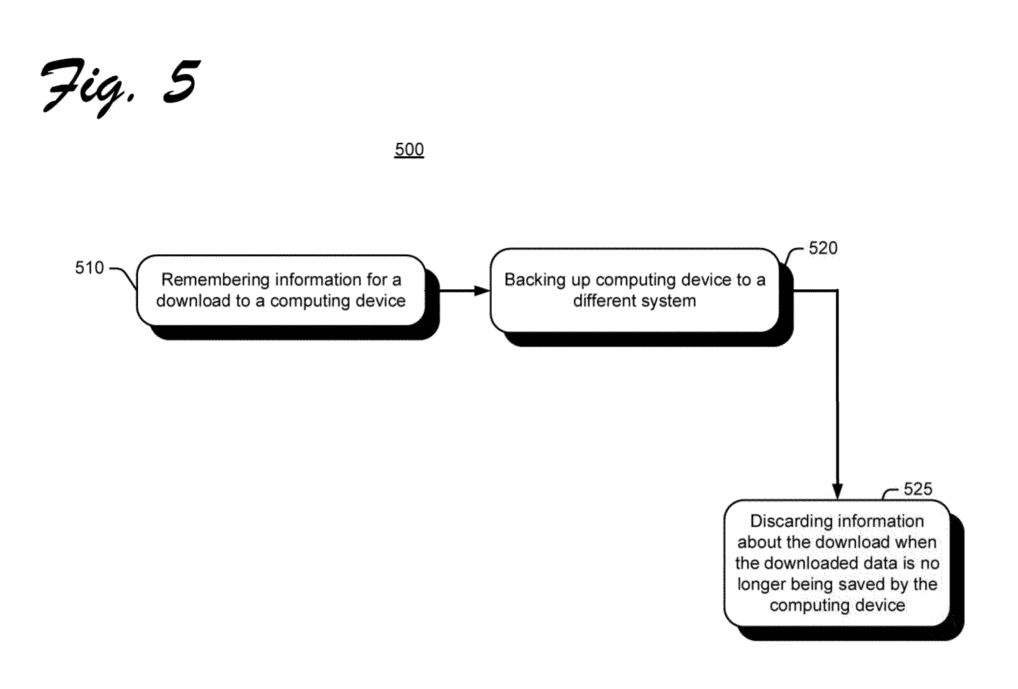

FIG. 3 is a high-level illustration of reducing backup bandwidth by remembering the sources of downloads to a computing device. In this illustration, the computing device storage 300 includes a variety of different data types. For example, locally provided data 310a may be provided by a camera device 320 (e.g., a smart phone camera or loaded onto a laptop from a separate camera), application software 310b installed from installation disk 325, and locally generated data 310c (e.g., word processing documents).

The computing device storage 300 also includes a variety of downloaded data. For example, application software 330a may have been downloaded from the Internet or other network site (e.g., an enterprise network) for installation on the computing device. In another example, downloaded data 330b such as videos, music, and PDF files may have been downloaded from the Internet or other network site.

The computing device in this illustration may be associated with an online or cloud backup service 340, which backs up data in the computing device storage 300 in an off-site data store 345 (e.g., in the cloud or at an enterprise data center). Uploading 301 all of the data from the computing device storage 300 to the data store 345 consumes expensive and potentially limited bandwidth that could be used to speed up other network communications, and can slow processes at the computing device during the backup process.

Instead, the backup service 340 may use remembered information about the data stored on the computing device storage 300. This remembered information 350 may be kept by the computing device and includes at least the sources of the downloaded data. For example, the computing device may have downloaded 302 application software 330a and/or downloaded data 330b from network site(s) 360. Accordingly, backup agent 232 remembers that application software 330a and/or downloaded data 330b was downloaded from the network site(s) 360, and therefore does not upload application software 330a and/or downloaded data 330b as part of the backup.

Only data that was not downloaded (e.g., locally provided data 310a, locally installed application software 310b, and locally generated data 310c) is uploaded 301 to the data store 345. In an example, the backup service 340 retrieves the downloaded data 330a-b directly from the source 360 and stores the downloaded data 330a-b in the data store 345 as part of the backup process.

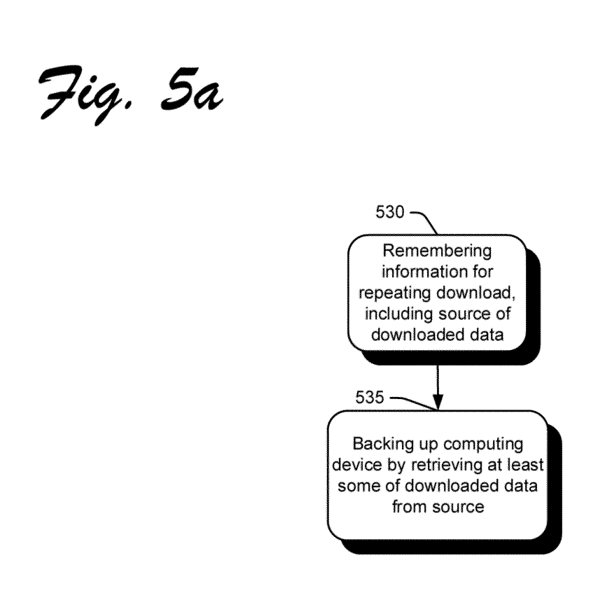

FIG. 4 is a high-level illustration of reducing backup bandwidth by remembering downloads to a computing device via a proxy. Again, the computing device storage 400 is shown with a variety of example data types: locally provided data 410a provided by a camera device 440, application software 410b installed from an installation disk 325, and locally generated data 410c. The computing device storage 400 is also shown including a variety of example downloaded data: application software 430a and downloaded data 430b.

The computing device in this illustration may be associated with an online or cloud backup service 440, which backs up data in the computing device storage 400 at data store 445. Again, uploading 401 all of the data from the computing device storage 400 to the data store 445 consumes expensive and limited bandwidth that could be used to speed up other network communications, and can slow processes at the computing device during the backup process.

Instead, the backup service 440 may use remembered information 450 (e.g., provided by the proxy node(s) 470) about the data downloaded to the computing device storage 400. In this illustration, all downloads 402 to the computing device storage 400 were via the proxy 470. For example, when the computing device downloaded 402 application software 430a and/or downloaded data 430b from network site(s) 460, the proxy 470 remembered information about the downloaded information (e.g., a URL) and/or also stored a copy of that data, e.g., in data store 475 (although the proxy may also be associated with data store 445 of the backup service 440).

Accordingly, the backup service 440 and/or proxy node(s) 470 remembers that application software 430a and/or downloaded data 430b was downloaded via the proxy 470, and therefore does not have to upload application software 330a and/or downloaded data 330b from computing device 230 as part of the backup.

Again, only data that was not downloaded (e.g., locally provided data 410a, locally installed application software 410b, and locally generated data 410c) is uploaded 401 by the backup service 440 to the data store 445 In an example, the backup service 440 retrieves the application software 330 and downloaded data 430b from the proxy 470.

It is noted that the backup service in any of these illustrations (FIGS. 3-4) may be provided for multiple computing devices. As such, there is a likelihood that more than one computing device using the backup service may be storing the same downloaded data. For example; each computing device in an enterprise may have the same application software installed. But storing multiple instances of the same application software is an inefficient use of storage capacity, and an inefficient use of the backup process. As such, the backup service may store a single copy of the application software (or other downloaded data) in the data store 345/445, with the backup manifest of each backup containing that application software referring to the single copy. This technique is called single instancing and is well known. Then during a restore operation when the backup service is restoring one of these backups, the backup service can restore the application software from the commonly stored version of the application software (or other downloaded data).

Although shown separately, the techniques illustrated by FIGS. 3 and 4 may be combined. For example, the backup service may use a combination of storing downloaded data, pointing to a source of downloaded data, and/or using a proxy service.

Before continuing, it should be noted that the examples described above are provided for purposes of illustration, and are not intended to be limiting. Other devices and/or device configurations may be utilized to carry out the operations described herein.

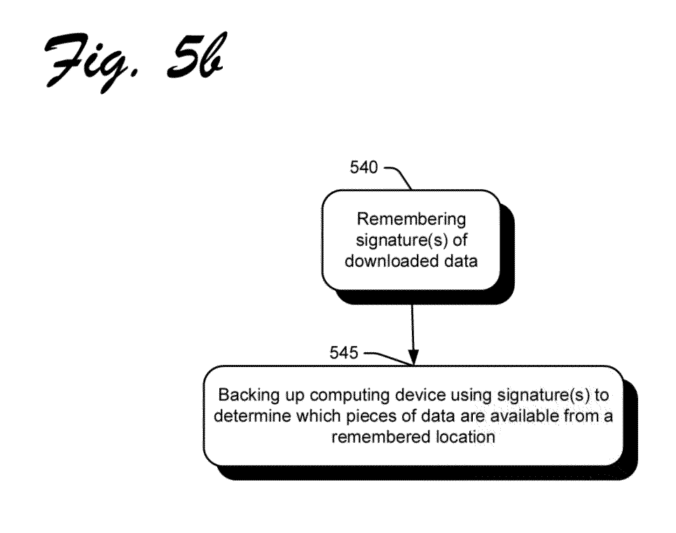

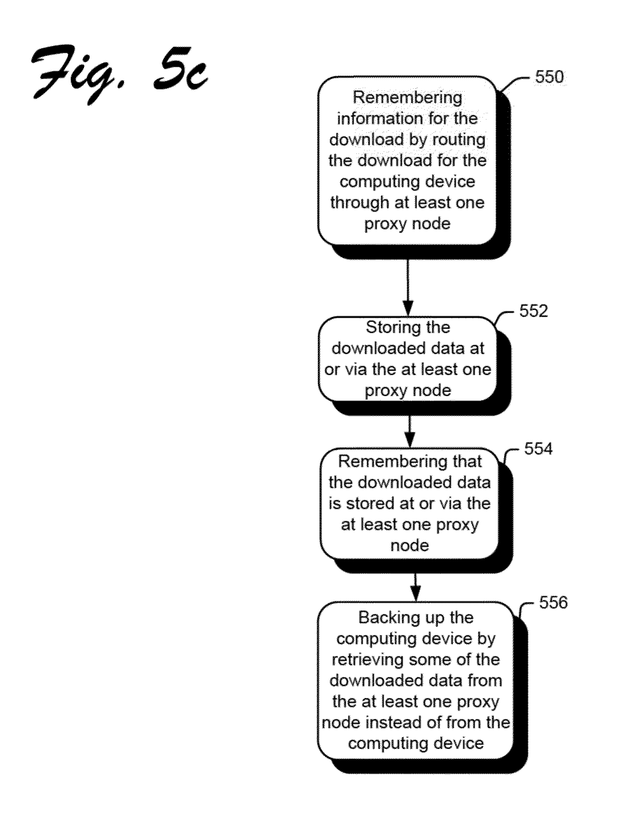

FIGS. 5 and 5a-c are flowcharts illustrating example operations that may be implemented to reduce bandwidth usage of a computing device. Operations may be embodied as logic instructions on one or more computer-readable medium. When executed on one or more processors, the logic instructions cause a general purpose computing device to be programmed as a special-purpose machine that implements the described operations. In an example, the components and connections depicted in the figures may be used.

FIG. 5 illustrates operations 500. Operation 510 includes remembering information for a download to a computing device. Operation 520 includes backing up the computing device to a different system. The information remembered for the download is used to provide a backup of the computing device without having to copy or upload at least some of the downloaded data present on the computing device from the computing device. Operation 525 includes discarding information about the download when the downloaded data is no longer being saved by the computing device. This may involve receiving a notification for the at least one proxy node to discard its copy of the downloaded data and/or information about the downloaded data.

The operations shown and described herein are provided to illustrate example implementations. It is noted that the operations are not limited to the ordering shown. Still other operations may also be implemented.

FIG. 5a illustrates sub operations 530 and 535. Operation 530 includes remembering information for repeating the download, including a source of the downloaded data. Accordingly, operation 535 may include backing up the computing device by retrieving at least some of the downloaded data from the source of the downloaded data instead of from the computing device.

FIG. 5b illustrates sub operations 540 and 545. Operation 540 includes remembering one or more signatures for one or more pieces of the downloaded data. Accordingly, operation 545 includes backing up the computing device by using the one or more signatures to determine which pieces of data on the computing device are available from a remembered location.

FIG. 5c illustrates sub operations 550-556 Operation 550 includes remembering information for the download by routing the download for the computing device through at least one proxy node. Operation 552 includes storing the downloaded data at or via the at least one proxy node. Operation 554 includes remembering that the downloaded data is stored at or via the at least one proxy node. Accordingly, operation 556 includes backing up the computing device by retrieving some of the downloaded data from the at least one proxy node instead of from the computing device.

The operations may be implemented at least in part using an end-user interface (e.g., web-based interface). In an example, the end-user is able to make predetermined selections to configure the backup operation, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method of reducing backup bandwidth by remembering downloads to a computing device, comprising:
remembering information for a download to a computing device; and
backing up the computing device to a different system, wherein the information remembered for the download is used to provide a backup of the computing device without copying some of the downloaded data present on the computing device from the computing device.

2. The method of claim 1, wherein remembering information for the download further comprises remembering information for repeating the download, including a source of the downloaded data.

3. The method of claim 2, wherein backing up the computing device further comprises retrieving some of the downloaded data from the source of the downloaded data instead of from the computing device.

4. The method of claim 1, wherein remembering information for the download further comprises remembering one or more signatures for one or more pieces of the downloaded data.

5. The method of claim 4, wherein backing up the computing device further comprises using the one or more signatures to determine which pieces of data on the computing device are available from a remembered location.

6. The method of claim 1, wherein remembering information for the download further comprises:
routing the download for the computing device through at least one proxy node;
storing the downloaded data at the at least one proxy node; and
remembering that the downloaded data is stored at the at least one proxy node.

7. The method of claim 6, further comprising receiving a notification for the at least one proxy node to discard the downloaded data when the downloaded data is not saved by the computing device.

8. The method of claim 6, wherein backing up the computing device further comprises retrieving some of the downloaded data from the at least one proxy node instead of from the computing device.

9. A system for reducing backup bandwidth by remembering downloads to a computing device, comprising:
an information store to store remembered information for a download to a computing device; and
machine readable code stored in non-transient computer-readable media, the machine readable code executable by at least one processor to backup the computing device to a different system, wherein the remembered information for the download is used to provide a backup of the computing device without copying some of the downloaded data from the computing device.

10. The system of claim 9, wherein the remembered information for the download further comprises information to repeat the download.

11. The system of claim 9, wherein the remembered information for the download further comprises one or more signatures for one or more pieces of the downloaded data.

12. The system of claim 9, wherein the remembered information for the download further comprises information identifying an online source of the downloaded data.

13. The system of claim 11, wherein the backup of the computing device retrieves some of the downloaded data from the source of the downloaded data.

14. The system of claim 12, wherein the backup of the computing device uses the one or more signatures to determine which pieces of data on the computing device are available from the source.

15. The system of claim 9, wherein the machine readable code is further executable by the at least one processor to:
route the download for the computing device through at least one proxy node;
store the downloaded data at the at least one proxy node; and
remember that the downloaded data is stored at the at least one proxy node.

16. The system of claim 15, wherein the machine readable code is further executable by the at least one processor to discard the downloaded data when the downloaded data is not saved by the computing device.

17. The system of claim 15, wherein the machine readable code is further executable by the at least one processor to retrieve some of the downloaded data from the at least one proxy node instead of from the computing device.

18. A system for reducing backup bandwidth by remembering downloads to a computing device, comprising program code stored on non-transient computer-readable storage media, the program code executable by at least one processor to:
remember information for a download to a computing device; and
backup the computing device to a different system;
wherein the information remembered for the download is used to provide a backup of the computing device without copying some of the downloaded data present on the computing device from the computing device.

19. The system of claim 18, wherein the program code is further executable by the at least one processor to:
determine which pieces of data on the computing device are available from a source of the downloaded data; and
retrieve those pieces of the data from the source of the downloaded data.

20. The system of claim 18, wherein the program code is further executable by the at least one processor to:
route the download for the computing device through at least one proxy node;
store the downloaded data at the at least one proxy node; and
remember that the downloaded data is stored at the at east one proxy node.
